(19) United States
(12) Patent Application Publication
(10) Pub. No.: US 2025/0037256 A1
(43) Pub. Date: Jan. 30, 2025

(54) INTERPRETIVE AND QUALITATIVE ASSESSMENTS OF DOCUMENT IMAGE QUALITY FOR DOCUMENT IMAGE SUBMISSIONS

(71) Applicant: PAYPAL, INC., San Jose, CA (US)

(72) Inventors: Chao Wang, Shanghai (CN); Ke Jin, Shanghai (CN); Wei Sun, Singapore (SG)

(21) Appl. No.: 18/361,200

(22) Filed: Jul. 28, 2023

(51) Int. Cl. G06T 7/00; G06Q 20/40; G06V 10/82; G06V 30/413; G06V 30/42

(52) U.S. Cl. CPC G06T 7/0002; G06Q 20/401; G06V 10/82; G06V 30/413; G06V 30/42; G06T 2207/20081; G06T 2207/20084; G06T 2207/30168; G06T 2207/30201; G06V 10/774; H04N 23/64

(57) ABSTRACT

There are provided systems and methods for interpretive and qualitative assessments of document image quality for document image submissions. A service provider, such as an electronic transaction processor for digital transactions, may provide computing services to users, which may be used to engage in interactions with other users and entities including for electronic transaction processing. When utilizing these services, document verification may be required to verify a document. A user may capture an image of a document, such as a driver's license, and an image quality assessment engine may process the image using a pipeline of neural networks configured to provide interpretive and qualitative assessments. A first neural network may determine key information fields present in the image for the document and a document type for the document in the image. A second neural network may then determine image data quality for the fields in the image.

### TECHNICAL FIELD

The present application generally relates to image data extraction and processing and more particularly to utilizing machine learning (ML) models and neural networks (NNs) for document image quality assessments.

### BACKGROUND

Service providers may provide computing services to customers, clients, and users through computing systems and services that provide platforms, websites, applications, and interfaces for interactions. Before service providers provide certain computing services to users, images of documents may be submitted for proof of identification, validity, possession, authentication, and the like, as well as image data extraction, such as user images, text, and the like. The service providers may provide document image submission systems and processes, which allow users to capture an image or the like of a physical document and upload that image for processing. However, processing may take a significant amount of time and results may not be immediately provided to the user where the document may be required to be parsed, processed, and analyzed by artificial intelligence (AI) systems, such as machine learning (ML) models, neural networks (NNs), and the like for image and/or text data identification, extraction, and processing, such as to determine relevant content and/or the authenticity of the document or image. Further, document verification pass rates from images may be significantly impacted by the quality of document images that are uploaded by customers. Low quality document images (e.g., having blur, having glares or other unwanted light or image effect sources, of low resolution, missing key information, etc.) may lead to a low pass rate of document image submissions with an overall document verification process. This low pass rate may cause a high cost to service providers when verifying document images (e.g., an increased cost of 20%, loss of customer base, lost transaction or other payments, slow or delayed payments and transaction processing, etc.), as well as a bad user experience. These bad user verification experiences may cause users to drop off and give up using service provider computing services and resources. As such, it is desirable to provide accurate and precise image quality assessments of document images in real-time or near real-time to allow for user corrections and resubmissions when images may be of poor or inadequate quality.

### BRIEF DESCRIPTION OF THE DRAWINGS

FIG. 1 is a block diagram of a networked system suitable for implementing the processes described herein, according to an embodiment;

FIG. 2 is an exemplary system architecture of a neural network pipeline that may be used for interpretive and qualitative assessments of document image quality using image data from key information fields, according to an embodiment;

FIG. 3A-3B are exemplary diagrams of images processed by a neural network trained for interpretive and qualitative assessments of document image quality through assessing image data in key information fields, according to an embodiment;

FIG. 4 is a flowchart for interpretive and qualitative assessments of document image quality for document image submissions, according to an embodiment; and

FIG. 5 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for an ML model and/or NN framework and pipeline for interpretive and qualitative assessments of document image quality for document image submissions. Systems suitable for practicing methods of the present disclosure are also provided.

In computing systems of service providers, computing services may be used for electronic transaction processing, account creation and management, payment and transfer services, customer relationship management (CRM) systems that provide assistance, reporting, sales, and the like, and other online digital interactions. In this regard, computing services and systems may provide computing services to users through various platforms that may require users to verify their identity, authenticate themselves, validate their information, provide supporting documentation for service provision and/or proof of an event, and/or otherwise submit documents and documentation to the service provider for analysis. Such, data may be provided through uploads to different platforms and websites or applications, as well as through communications via an email channel, a digital alert channel, a text message channel, a push notification channel, an instant message channel, or other messaging channel. In this regard, paper or physical documents may be scanned, imaged, or otherwise converted to digital form by user devices, such as mobile phones and cameras. However, document verification pass rates may be a problematic hurdle and significantly impacted by the quality of document images that are uploaded by customers and other users. Documents may include imaging artifacts including blur, glare, low resolution, missing fields or improperly captured images and the like that leads to a low pass rate, a low verification rate, and/or an inaccurate verification determination, as well as bad customer experience and customer drop-off or turnover.

Thus, when providing these computing services that require document verification, the service provider's system and architecture may implement a multiple NN or other ML model framework and pipeline, executed by one or more processors and/or engines, that provides interpretive and qualitative assessments of document image quality for document image submissions. This may be done by training a first NN for object detection of key information fields (KIFs) in images for documents. KIFs may correspond to form fields, sections, areas, boxes, and the like that are present on documents and include information, images, and the like that are relevant to verifying the document and/or requested information from the user and/or extracting such information for use. For example, KIFs may include name, address, height, and the like from an identification card, or card number, expiration date, card verification value, and the like from a credit or debit card.

Training of the first NN for object detection and identification may be based on past or available images of documents, which may include labeling and other data identifying the KIFs and their identifiers or descriptions. The KIFs may be identified by the first NN in captured images when submitted. A second NN may be trained to assess a quality of the image data in the scanned document for each KIF, such as whether the image data of the scanned, captured, or imaged document allows for determination, reading, and/or extraction of the corresponding information for each KIF from the scanned, captured, or recorded image of the document. Training for the second NN may be done using image data for text, images, and other objects in images that may be read or extracted for analysis. This may correspond to using an image assessment NN. Further NNs may also be trained for object detection and/or quality assessment for the image processing pipeline for assessments of document image quality.

The NN pipeline may then be deployed to identify whether each KIF is present in an image of a document, what type of document is present in the image, and whether the quality of the image data present for each KIF is of a sufficient quality, such as a high enough score for clarity, that the document may be submitted for verification. Using the NN pipeline for image quality assessments, the service provider may then provide feedback and responses when documents are submitted as to whether such documents may be accepted and verified, as well as approve or reject submissions. Further, the service provider may provide information, messages, and the like regarding interpretive and qualitative assessments of document image quality, which may include why documents may fail document verification and/or why an image of a document may need to be recaptured or resubmitted. This may include missing KIFs and/or KIFs with insufficient information and/or unreadable or unextractable image data. This may include suggestions on how to recapture images of documents to improve verification success. As such, users may have a more comprehensive understanding of why documents may fail submissions for verifications and how to properly submit documents, thereby reducing unnecessary processing of poor or bad images, wasted resources processing such images, and other system inefficiencies caused by wasted time and resources when automated document verification and image data extraction fails.

Such verification may be needed before a service provider provides computing services to users including electronic transaction processing. For example, an online transaction processor (e.g., PayPal®) may allow merchants, users, and other entities to process transactions, provide payments, transfer funds, or otherwise engage in computing services. In other embodiments, other service providers may also or instead provide computing services for social networking, microblogging, media sharing, messaging, business and consumer platforms, etc. In order to utilize the computing services of a service provider, an account with the service provider may be established by providing account details, such as a login, password (or other authentication credential, such as a biometric fingerprint, retinal scan, etc.), identification information to establish the account (e.g., personal information for a user, business or merchant information for an entity, or other types of identification information including a name, address, and/or other information), and/or financial information. All of these interactions may generate and/or process data, which may require verification of documents in possession of users, including text and/or image documents, forms, cards, and the like. In order to provide comprehensive, interpretive, and qualitative assessments of image quality for images taken of documents being verified, the service provider may provide an NN or other ML framework implementing NNs and other ML models, techniques, and algorithms for image data processing including object detections and image data quality assessments. When performing image assessments for document image submissions, a pipeline of NNs or other ML models may be used to provide feedback and outputs associated with whether document images are of sufficient quality, as well as how images of documents may be recaptured for better submissions, leading to higher verification rates of documents during automated and intelligent image processing and image data extraction.

In this regard, a service provider may provide an interpretive and qualitative document image quality assessment system and operations for object detection and classification using one or more neural networks in a framework and pipeline for image quality assessment. First, an object detection NN may be trained to predict what KIFs are present in an image and on the document in the corresponding image. The NN(s) may be trained to identify the type of a document present in an image (e.g., a drivers license, credit/debit card, bill, receipt, sales agreement, contract, etc.), and therefore the pattern, template, layout, or the like of the KIFs in the document. The KIFs may correspond to areas, segments, elements, sections, fields, boxes, or the like on a document that may include relevant information for reading, extracting, and/or verifying on the document, such as a full name, expiration date, date of birth (DOB), address, portrait or image of the user, document number, document title, signature, RealID symbol (e.g., with specific types of identification cards), and the like. The object detection network may then predict what KIFs exist in a given image of a document and where their location is in the image. Further, the network may also output the prediction of the document type of the document present in the image.

Thereafter, an object classification NN may be trained to predict scores or qualities of the image data in the KIFs and assess each KIF's quality that was identified and output by the object detection NN. For example, a KIF may be present in an image, such as a field for a DOB, but the corresponding image data may be unreadable and therefore unable to be extracted and/or verified. The object classification network may predict whether a KIF has a good image quality and is of sufficient quality to allow for image reading, identification, extraction, and/or viewing by a user, which may be used to verify the data and/or document, as well as authenticate the user and/or validate user information. The objection classification NN may predict and output a score to each KIF field and/or section in the image and on the document, such as for a corresponding text field or image. The confidence level or number of an optical character recognition (OCR) system or the like may recognize text from the KIF, which a score for readable text may be determined. For a portrait or other image, graphic, or the like on the document, the image data may be scored, and image quality may be determined by an image or objection detection NN and operations. Such image or object detection and classification may include how many face landmarks (e.g., a number of present or identifiable landmarks used for image processing and data extraction) can be found from the face in the portrait, a score for another image field like RealID (e.g., the possibility (score or number) of a field being a RealID symbol, etc.).

Thereafter, the system may calculate an overall document quality score base on the type of the document and the score for each KIF area, section, portion, or field in the image of the document. The score may be calculated as follows as an overall quality score, which may include utilizing an algorithm or function to weight each KIF area and corresponding score, determining a ratio based on the total KIF areas or scores, and/or calculating the overall quality score based on these inputs to the algorithm. Thus, the KIFs that count to a quality score calculation may depend on a document type, and a threshold may be used to control overall pass rate of images of documents prior to submission, processing, and the like. For example, a US California Driver License having a quality score lower than 0.6 may be identified as a low-quality document. This may be done in real-time or near real-time using the trained NNs and pipeline for predicting and scoring so that a user may view a decision as to whether their image submission is adequate, needs retaking with a further image capture and/or image adjustment (e.g., cleanup, image processing or aftereffect adjusting, etc.). Further, any scores of zero (or lower than a certain threshold score) may indicate that the KIF is not present or data is unable to be extracted and/or read, which may automatically cause the image to be identified as a poor-quality document image and require retaking, resubmission, or the like (e.g., if one field is entirely absent or unreadable).

These NNs and/or other ML models in the image processing and quality assessment pipeline may allow the overall document verification system pass rates to be dynamically controlled in real-time and allow for users to submit proper and acceptable quality documents quickly and without need for resubmissions after later system feedback. This may avoid unnecessary inputs and image processing, as well as further requests to users where the user may not have access to the document, suffer an adverse effect by having the document not submitted, or otherwise have a poor customer experience with document submissions. Further, the image assessment system may allow the system to indicate the location and identify quality issues in image data captured of the document (e.g., blur on a name section, missing date of birth section, etc.) so that users may troubleshoot and recapture documents having proper data without long and complicated resubmission processes or loss of service provision when a document is insufficient and/or unverified. Thus, the service provider's intelligent image quality assessment framework for document submissions may provide guided submissions and information on resubmissions in a fast and accurate manner that is performed through automated computing systems without manual efforts and intervention. This prevents small image issues from leading to the failure of a document submission process, as well as assist such image submission and processing systems with capturing and processing image of sufficient quality to adequately extract and process document data

The NN and other ML model framework may be generalized and customizable for different purposes and focuses as required by the service provider for different types of images and/or documents requiring data verification of KIFs and other sections of data found in such images. For example, in transaction authorization and review, images may be captured of receipts, items and/or item verifications (e.g., SKUs, product or inventory numbers and identifiers, barcodes or QR codes, etc.), purchased items or services (e.g., an image of an item that a user purchased for proof of purchase) and the like. With this automated framework, the service provider may facilitate data extraction and verification of documents and objects in images by confirming whether images are of sufficient quality to verify such transaction information and/or extract data from such images. Where images may be of insufficient quality, the framework may provide suggestions and recommendations to recapture images and/or adjust image capture components and features so that data may be properly verified, including identifying areas of insufficient quality in such images. This can improve operational efficiency and effectiveness by ensuring submitted documents are of sufficient quality for data processing and image data extraction. In this manner, the service provider's system for automated image processing may be made more efficient, faster, and require less monitoring and manual efforts for document verification.

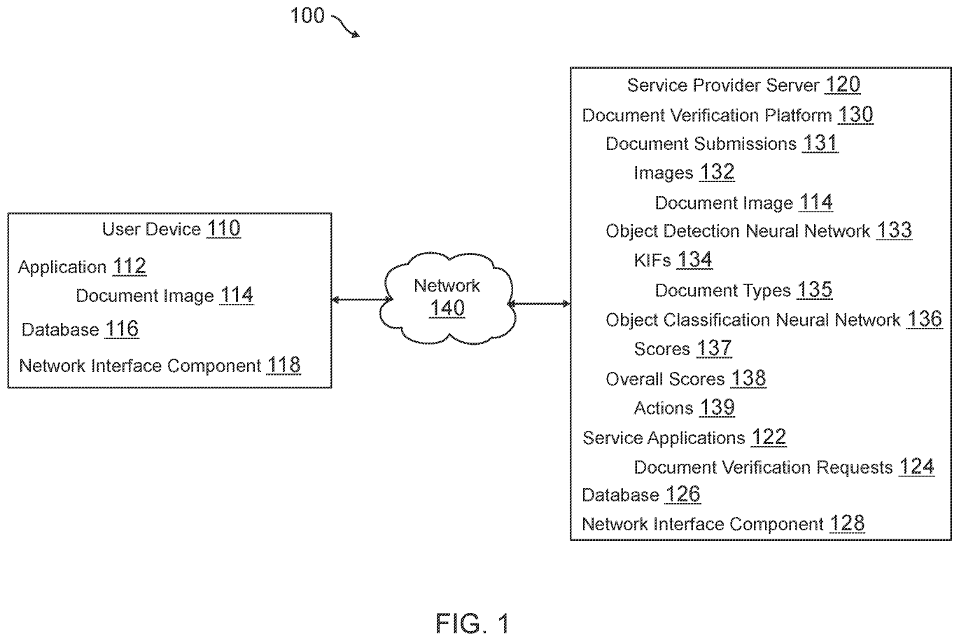

FIG. 1 is a block diagram of a networked system 100 suitable for implementing the processes described herein, according to an embodiment. As shown, system 100 may comprise a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, or another suitable device and/or server-based OS. It can be appreciated that the devices and/or servers illustrated in FIG. 1 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entity.

FIG. 1 provides an overview of system 100 to implement NNs and/or other ML models used for interpretive and qualitative assessments of document image quality for document image submissions. System 100 includes a user device 110 and a service provider server 120 in communication over a network 140. User device 110 may be utilized by a user, customer, or entity to access a computing service or resource provided by service provider server 120, where service provider server 120 may provide various data, operations, and other functions to user device 110 via network 140. In this regard, user device 110 may be used to provide images of documents that are requested to be verified by service provider server 120. As such, service provider server 120 may analyze and process such images to determine whether the images are of sufficient quality for submission for document verification of the documents in such images, as well as information regarding insufficient quality images or portions of images with recommendations for repairing, recapturing, or otherwise remedying such quality issues.

User device 110 and service provider server 120 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 140.

User device 110 may be implemented as a communication device that may utilize appropriate hardware and software configured for wired and/or wireless communication with service provider server 120 and other devices and/or servers. For example, in one embodiment, user device 110 may be implemented as a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one device is shown, a plurality of devices may function similarly and/or be connected to provide the functionalities described herein.

User device 110 of FIG. 1 contains an application 112, a database 116, and a network interface component 118. Application 112 may correspond to executable processes, procedures, and/or applications with associated hardware. In other embodiments, user device 110 may include additional or different modules having specialized hardware and/or software as required.

Application 112 may correspond to one or more processes to execute modules and associated devices of user device 110 to provide a convenient interface to permit a user for user device 110 to utilize services of service provider server 120, including computing services that may include providing and submitting documents for verification via images or other digital copies, as well as responding to document image assessments. Where service provider server 120 may correspond to an online transaction processor, the computing services may include those to enter, view, and/or process transactions, onboard and/or use digital accounts, and the like, which may including providing, verifying, and/or validating documents and other physical objects via images of those objects taken by user device 110 and transmitted to service provider server 120. Such images may be provided when engaging in, as well as before or after and in support of, electronic transaction processing or other computing services associated with digital payment accounts, transactions, payments, and/or transfers.

In this regard, application 112 may correspond to specialized hardware and/or software utilized by user device 110 that may provide transaction processing and other computing service usage through a user interface enabling the user to enter and/or view data, input, interactions, and the like for processing. This may be based on a transaction generated by application 112 using a merchant website or seller interaction, or by performing peer-to-peer transfers and payments with merchants and sellers. Application 112 may be associated with account information, user financial information, and/or transaction histories. However, in further embodiments, different services may be provided via application 112, including messaging, social networking, media posting or sharing, microblogging, data browsing and searching, online shopping, and other services available through service provider server 120. Thus, application 112 may also correspond to different service applications and the like that are associated with service provider server 120.

In this regard, when providing document images and other images of objects for verification and approval, application 112 may capture and transmit document image 114 to service provider server 120. Document image 114 may correspond to a document having text, graphics, images, visual content, and the like in one or more KIFs, which may be processed to assess a quality for submission with a document review, verification, and/or approval process discussed herein. Service provider server 120 may receive document image 114 with other document submission and/or verification and may process to determine whether KIFs are present for a corresponding document type, as well as the quality of image data present in such KIFs, as discussed herein. Thus, application 112 may include processes to capture, load, and/or provide document image for processing by service provider server 120, as well as output document image quality responses and assessments. Such assessments may include identification of poor quality images and/or image areas, as well as instructions for recapture of the document or adjustment of the image. In various embodiments, application 112 may correspond to a general browser application configured to retrieve, present, and communicate information over the Internet (e.g., utilize resources on the World Wide Web) or a private network. For example, application 112 may provide a web browser, which may send and receive information over network 140, including retrieving website information, presenting the website information to the user, and/or communicating information to the website. However, in other embodiments, application 112 may include a dedicated software application of service provider server 120 or other entity (e.g., a merchant) resident on user device 110 (e.g., a mobile application on a mobile device) that is displayable by a graphical user interface (GUI) associated with application 112.

User device 110 may further include database 116 stored on a transitory and/or non-transitory memory of user device 110, which may store various applications and data and be utilized during execution of various modules of user device 110. Database 116 may include, for example, identifiers such as operating system registry entries, cookies associated with application 112, identifiers associated with hardware of user device 110, or other appropriate identifiers, such as identifiers used for payment/user/device authentication or identification, which may be communicated as identifying the user/user device 110 to service provider server 120. Moreover, database 116 may include information for document image 114 and/or results of document image 114 processing, which may be presented and/or output via application 112.

User device 110 includes at least one network interface component 118 adapted to communicate with other computing devices, servers, and/or service provider server 120. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Service provider server 120 may be maintained, for example, by an online service provider, which may provide computing services, including electronic transaction processing, via network 140. In this regard, service provider server 120 includes one or more processing applications which may be configured to interact with user device 110 to provide data, user interfaces, platforms, operations, and the like for the computing services to user device 110, as well as facilitate interpretive and qualitative assessments of document image quality for document image submissions. In one example, service provider server 120 may be provided by PAYPAL®, Inc. of San Jose, CA, USA. However, in other embodiments, service provider server 120 may be maintained by or include another type of service provider.

Service provider server 120 of FIG. 1 includes a document verification platform 130, service applications 122, a database 126, and a network interface component 128. Document verification platform 130 and service applications 122 may correspond to executable processes, procedures, and/or applications with associated hardware. In other embodiments, service provider server 120 may include additional or different modules having specialized hardware and/or software as required.

Document verification platform 130 may correspond to one or more processes to execute modules and associated specialized hardware of service provider server 120 to provide a platform for analysis of document submissions 131, having images 132 including document image 114 from user device 110, to determine a quality of image data present for KIFs and whether images 132 are of sufficient quality for document submissions 131 to be properly reviewed, have data extracted for, and/or verified. In this regard, document verification platform 130 may correspond to specialized hardware and/or software used by service provider server 120 to process document submissions 131 from document verification request 124 for service applications 122, which may be generated to verify documents and/or content in documents from use of service applications 122. This may be done using an NN or other ML model pipeline and engine that outputs overall scores 138 with actions 139 based on processing by an object detection NN 133 and an object classification NN 136. In this regard, document verification platform 130 may interact with service application 122 to receive, detect, collect, and/or otherwise determine that document submissions 131 have been provided for verification through document verification requests 124 from a corresponding domain, category, communication channel, or the like. Document verification requests 124 may be provided during use of a computing service and/or after on in conjunction with use, such as to provide a service to users through service applications 122.

Document verification platform 130 may execute NNs and ML models to generate overall scores 138 and actions 139 to take with respect to images 132 for document submissions 131. In various embodiments, document verification platform 130 includes NNs and ML models that may be used for intelligent decision-making and/or predictive outputs and services, such as during the course of providing interpretive and qualitative assessments of document image quality for document image submissions. Thus, ML models may provide a predictive output, such as a score, likelihood, probability, or decision, associated with assessment of image quality for images 132 to verify document submissions 131, such as to verify and/or extract document information from images 132 of documents requested during document verification requests 124. NNs and ML models of the image processing pipeline for document image quality assessments may employ a combination of different NNs and ML model algorithms including deep NNs, algorithms, and techniques for object location and classification. Although NN algorithms are discussed herein, it is understood other types of NNs, ML models, and AI-driven engines and corresponding algorithms may also be used.

For example, document verification platform 130 may include NNs trained for intelligent decision-making and/or predictive outputs (e.g., scoring, comparisons, predictions, decisions, classifications, and the like) for particular uses with computing services provided by service provider server 120 for document or user verification. When generating NNs, NN algorithms and trainers may be used to create NNs, and training data may be processed to generate one or more classifiers that provide recommendations, predictions, or other outputs based on those classifications and NN algorithms. Service provider server 120 may implement one or more NN algorithms to generate different object detection and classification NNs and NN task performances. Thus, document verification platform 130 may implement a pipeline of multiple NNs for image data processing to provide interpretive and qualitative assessments of document image quality for document image submissions, and may therefore include a combination of NNs trained using different algorithms to properly detect KIFs 134 with document types 135 in images 132 and generate scores 137 for quality assessments of image data for KIFs 134 in images 132.

When initially configuring NNs using corresponding algorithms, training data may be used to determine input features and utilize those features to generate NN architectures and corresponding NN outputs at an output layer. For example, NNs may include multiple layers, including an input layer, a hidden layer, and an output layer having one or more nodes, however, different layers may also be utilized. As many hidden layers as necessary or appropriate may be utilized. Each node within a layer is connected to a node within an adjacent layer, where a set of input values may be used to generate one or more output values or classifications. Within the input layer, each node may correspond to a distinct attribute or input data type that is used by the NN algorithms using feature or attribute extraction for input data.

Thereafter, the hidden layers may be generated with these attributes and corresponding weights using an NN algorithm, computation, and/or technique. For example, each of the nodes in the hidden layers generates a representation, which may include a mathematical ML computation (or algorithm) that produces a value based on the input values of the input nodes. The ML algorithm may assign different weights to each of the data values received from the input nodes. The hidden layer nodes may include different algorithms and/or different weights assigned to the input data and may therefore produce a different value based on the input values. The values generated by the hidden layer nodes may be used by the output layer node to produce one or more output values for the ML models that provide an output, classification, prediction, or the like. Thus, when the ML models are used to perform a predictive analysis and output, the input may provide a corresponding output based on the classifications trained for the ML models. As many hidden layers and nodes as necessary may be provided and trained, where each hidden layer is interconnected to the previous and next hidden layer and hidden layers are further interconnected to the input layer and output layer, creating a set of neurons of the NNs.

By providing input data when generating object detection NN 133 and object classification NN 136 for document verification platform 130, the nodes in the hidden layers may be adjusted such that an optimal output (e.g., a classification) is produced in the output layer. By continuously providing different sets of data and penalizing NNs when the outputs of the NNs are incorrect, the NN algorithms for document verification platform 130 (and specifically, the representations of the nodes in the hidden layers) may be adjusted to improve their performance in data classification. This data classification may correspond to object detection of KIFs 134 and document types 135 by object detection NN 133 and scores 137 by object classification NN 136 for image data corresponding to KIFs 134 with regard to verifying documents corresponding to document types 135. Using the NN algorithms, document verification platform 130 may be created to perform intelligent decision-making and predictive outputs. This may include generation of overall scores 138 and actions 139 by document verification platform 130.

Thus, overall scores 138 may be generated by taking images 132 corresponding to images of a document from document submissions 131 in response to document verification requests 124 from service applications 122 to users when utilizing computing services. The image data for images 132 may be filtered by document verification platform 130 and preprocessed, such as to provide general image cleansing, filtering noise, and the like. Further, document verification platform 130 may perform data preprocessing in order prepare the image data for object detection and classification.

Document verification platform 130 may first execute object detection NN 133, which may correspond to a specifically trained NN for object detection of KIFs 134 in images 132 and prediction of a corresponding one of document types 135 based on the documents in images 132 with KIFs 134 detected in images 132. Object detection NN 133 may be trained using past images of documents that are labeled with respect to their KIFs and document types so that KIFs 134 may be recognized, and document types 135 may be predicted in images 132 of documents. After executing object detection NN 133 to detect KIFs 134 and document types 135, document verification platform 130 may further perform a scoring operation for image data in KIFs 134 using object classification NN 136. During the scoring, object classification NN 136 may attempt to classify a quality of image data for each of KIFs 134 in images 132, which may be scored (e.g., 1 to 10 scale or the like). Object classification NN 136 may be trained using images having objects with annotations or labels for the objects, where the NN algorithm may be used during training to attempt to teach the NN how good of a quality each image is with respect to capturing the corresponding object. As such, object classification NN 136 may be used to determine and output scores 137 for image quality of corresponding image data in images 132 for KIFs 134.

Document verification platform 130 may then output overall scores 138, which indicate whether images 132 are of sufficient quality to be submitted for document verification requests 124. Overall scores 138 may be compared to a threshold score or requirement for document quality, and if meeting or exceeding such threshold, those ones of images 132 may be approved for corresponding ones of document submissions 131 to be provided for document verification requests 124 for document image processing, verification, and/or data extraction (e.g., using OCR or the like to extract image data). Actions 139 may indicate an approval to submit those ones of images 132. However, if at or below the threshold, those ones of images 132 may be designated for repair and/or recapture by actions 139. Repair by actions 139 may include one or more image processing and/or adjusting operations to attempt to fix corresponding ones of images 132, or portions within those of images 132, so that data can be properly read and/or verification. This may be done automatically without user input and/or image recapture. However, if certain ones of overall scores 138 are at or below the threshold or another minimum bar thresholds. Actions 139 may require recapture of the document in a further image. This may occur where one or more of KIFs 134 are not present or detected for a corresponding one of document types 135, if image data in one or more of KIFs 134 is unreadable, or the like. With image recapture, actions 139 may also indicate where the issue is in the images, what can be done during recapture to eliminate the issue, and other recommended steps for image capture to remedy the issues with document image quality.

Service applications 122 may correspond to one or more processes to execute modules and associated specialized hardware of service provider server 120 to process a transaction or provide another service to customers or end users of service provider server 120. For example, service applications 122 may include a transaction processing application and may correspond to specialized hardware and/or software used by service provider server 120 to providing computing services to users, which may include electronic transaction processing and/or other computing services provided by service provider server 120, such as in response to receiving transaction data for electronic transaction processing of transactions initiated using digital wallets. In some embodiments, service applications 122 may be used by users, such as a user associated with user device 110, to establish user and/or payment accounts, as well as digital wallets, which may be used to process transactions. Accounts may be accessed and/or used through one or more instances of a web browser application and/or dedicated software application executed by user device 110 and engage in computing services provided by service applications 122.

In various embodiments, financial information may be stored to the account, such as account/card numbers and information. A digital token for the account/wallet may be used to send and process payments, for example, through an interface provided by service applications 122. The payment account may be accessed and/or used through a browser application and/or dedicated payment application executed by user device 110 and engage in transaction processing through service applications 122. Service applications 122 may process the payment and may provide a transaction history to user device 110 for transaction authorization, approval, or denial. In other embodiments, service applications 122 may instead provide different computing services, including social networking, microblogging, media sharing, messaging, business and consumer platforms, etc. Such services may be utilized through user accounts, websites, software applications, and other interaction sources, which may request document verification to allow, enable, or provide certain computing services, verify users, and the like through document verification requests 124.

Service applications 122 may also provide additional features to service provider server 120 and/or user device 110. For example, service applications 122 may include security applications for implementing server-side security features, programmatic client applications for interfacing with appropriate application programming interfaces (APIs) over network 140, or other types of applications. Service applications 122 may contain software programs, executable by a processor, including one or more GUIs and the like, configured to provide an interface to the user when accessing service provider server 120, where the user or other users may interact with the GUI to more easily view and communicate information. In various embodiments, service applications 122 may include additional connection and/or communication applications, which may be utilized to communicate information to over network 140.

Additionally, service provider server 120 includes database 126. Database 126 may store various identifiers associated with user device 110. Database 126 may also store account data, including payment instruments and authentication credentials, as well as transaction processing histories and data for processed transactions. Database 126 may store financial information and tokenization data, as well as transactions, transaction results, and other data generated and stored by service applications 122. Further, database 126 may include data provided for document verification requests 124, including document submissions 131 having images 132. With regard to images 132, database 136 may store overall scores 138 and/or actions 139 determined for images 132 when providing for document verification.

In various embodiments, service provider server 120 includes at least one network interface component 128 adapted to communicate with user device 110 and/or other computing devices and servers directly and/or over network 140. In various embodiments, network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 140 may be implemented as a single network or a combination of multiple networks. For example, in various embodiments, network 140 may include the Internet or one or more intranets, landline networks, wireless networks, and/or other appropriate types of networks. Thus, network 140 may correspond to small scale communication networks, such as a private or local area network, or a larger scale network, such as a wide area network or the Internet, accessible by the various components of system 100.

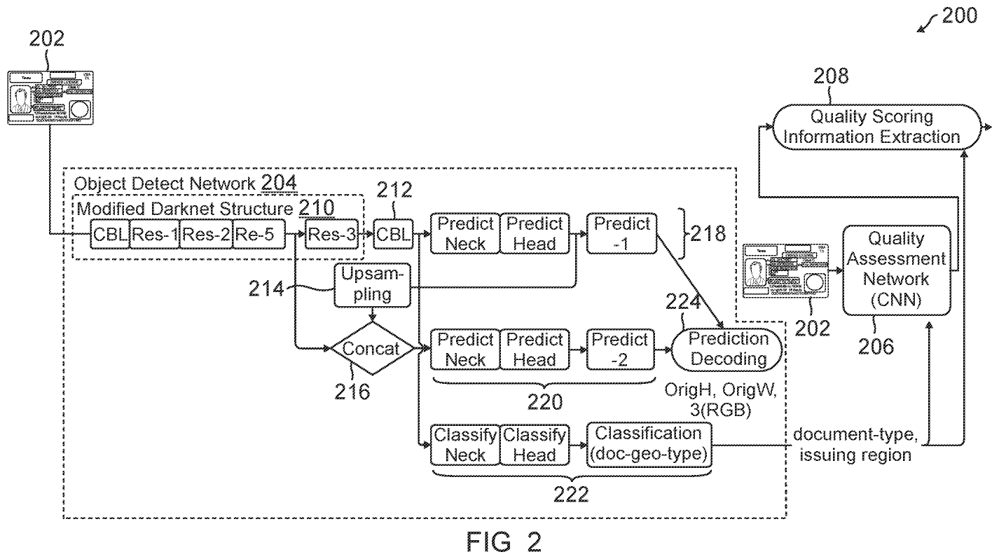

FIG. 2 is an exemplary system architecture 200 of a neural network pipeline that may be used for interpretive and qualitative assessments of document image quality using image data from key information fields, according to an embodiment. System environment 200 of FIG. 2 includes components of an NN framework for providing interpretive and qualitative assessments of document image quality for document image submissions, such as components of document verification platform 130 of service provider server 120 from system 100 of FIG. 1. In this regard, an identification card (ID card) 202 may be captured in an image and provided as input to the framework and NN pipeline in system environment 200 for analysis of image data for image quality when submitting an image of a document for document verification with a service provider and/or online platforms for service provision.

In system environment 200, ID card 202 is provided to an image processing system used in conjunction with document verification systems and applications to assess qualities of images of documents (e.g., ID card 202) in order to provide feedback on image quality and/or image capture for faster and more efficient document image processing during document verification. For example, ID card 202 may be provided to object detection network 204 that may process ID card 202 to identify KIFs in the image of ID card 202 (e.g., name, address, photograph of a user, ID card number, issuing state or region, etc.), as well as a document type for ID card 202 based on the image and/or identified KIFs (e.g., US state driver's license, Texas driver's license, US ID card, etc.). The output of the KIFs and document type may then be provided to an object assessment network 206, which may score the corresponding KIFs for quality of image data present for those KIFs, and determine an overall document image quality score or assessment for document image submission during document verification. The individual scores for each KIF may be based on a quality assessment using object assessment by object assessment network 206, and based on the scoring, quality/scoring information extraction 208 may be performed on the image of ID card 202. Thereafter, an assessment may be output, which may include a positive assessment for submission and document verification, a negative assessment and attempt to repair or otherwise provide the data for missing KIFs or data that is unclear or unreadable for KIFs, and/or a negative assessment with request to capture another, second or further, image of the document for review and assessment of whether the image quality is sufficient for reading, verifying, and/or extracting data for the document.

Object detection network 204 may correspond to a multilayer NN that may include an input layer configured to take, as input, features of the image of ID card 202, process such features using hidden layers having nodes and interconnections between nodes making up neurons of the NN, and an output layer that outputs predictions of KIFs and other areas of importance for ID card 202 in the image. For example, object detection network 204 may include different layers and/or networks for ResNets Blocks, ConvNet-BatchNorm-LeakyRelu (CBL) Blocks, and the like. Block may refer to a few layers organized in an order, such as a ConvNet layer followed by a BatchNorm layer, then followed by a LeakyRu layer (e.g., a CBL block). In this regard, object detection network 204 includes a modified darknet structure 210 including a CBL and one or more ResNets, although other structures may be used. A CBL layer 212 may be connected to modified darknet structure 210, which may be used for a first layer prediction 218, such as a presence of a particular image object. An upsampling layer 214 may be used with CBL layer for first layer prediction 218. Additionally, a concatenation layer 216 may also be connected with modified darknet structure 210 to provide a second layer prediction 220. Second layer prediction 220 may be used to increase the capability of finding different sized KIFs depending on different image captures, sizes, orientations, or the like in images. For example, a DOB field may be small in an image where a document occupies only a portion of the image, but large in an image where the document occupies nearly the whole image.

First layer prediction 218 and second layer prediction 220 may be combined with prediction decoding 224 to provide output predictions of objects in an image of a document. These predicted objects may correspond to KIFs in the image and for corresponding areas or sections of relevant document data of the document in the image. Further, CBL layer 212 may also be used and/or connected with a layer for a document type layer prediction 222, which may be used to classify ID card 202 in the image as a particular document type, such as one of a US ID card, state ID card, state driver's license, or the like. Output of object detection network 204 may then be provided with the image of ID card 202 to quality assessment network 206 for further processing to provide interpretive and qualitative assessments of document image quality for document image submissions.

Quality assessment network 206 may correspond to a specialized or out-of-the-box (OOTB) NN solution and trained model or network for assessment of object presence and clarity or quality in the image, such as a residual network (ResNet) or other type of convolution neural network (CNN, where CNN may refer to the collective name of network architectures that use convolution operations, such as a ConvNet layer) trained for object assessment in images. By scoring each of the KIFs' corresponding image data for object assessment and image quality (e.g., clarity of present of the underlying document data in the image), quality assessment network 206 may provide scores that may then be processed to compute and calculate an overall document image quality score or assessment, such as how likely the image is to be processed and/or approved for submission with a document verification system. Approval for submission may not indicate that the document is accepted and/or verified, such as if the document is fraudulent, incorrect, missing information or has incorrect information, or the like. However, the assessment may indicate whether the image is of sufficient quality to allow for document verification to proceed with the document captured in the image.

Each of the scores for quality of the document image data for each KIFs may then be combined and/or calculated in an overall document quality score for use with providing feedback and assessments when images are captured of documents for submission. Thus, quality assessment network 206 may provide an assessment or another indicator and/or score indicating the quality of the image with regard to properly and clearly capturing the document. In one embodiment, the overall document quality score may be calculated using the following equation: OverallQualityScore=(FullNameArea*FullNameScore+DOBArea*DOBScore+DocNumArea*DocNumScore+ . . . +PortraitArea*PortraitScore)/AllKIFArea. Quality assessment network 206 may provide quality/scoring information extraction 208 that indicates positive and/or negative quality areas and/or scores for areas in images corresponding to KIFs, as well as information on how to fix, remedy, or change the image and/or image capture to resolve issues in quality. As such, quality/scoring information extraction 208 may provide outputs that provide feedback to users for tips, suggestions, and/or recommendations on obtaining sufficiently high-quality images to proceed with image submission of a document during document verification.

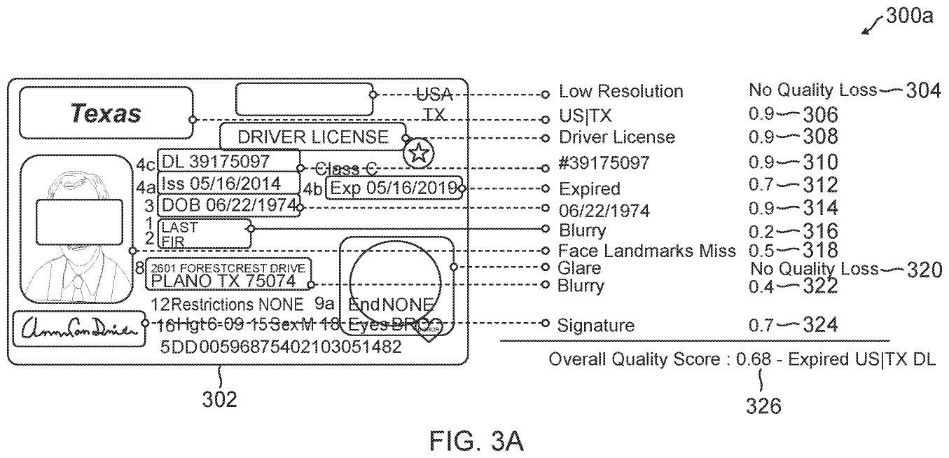

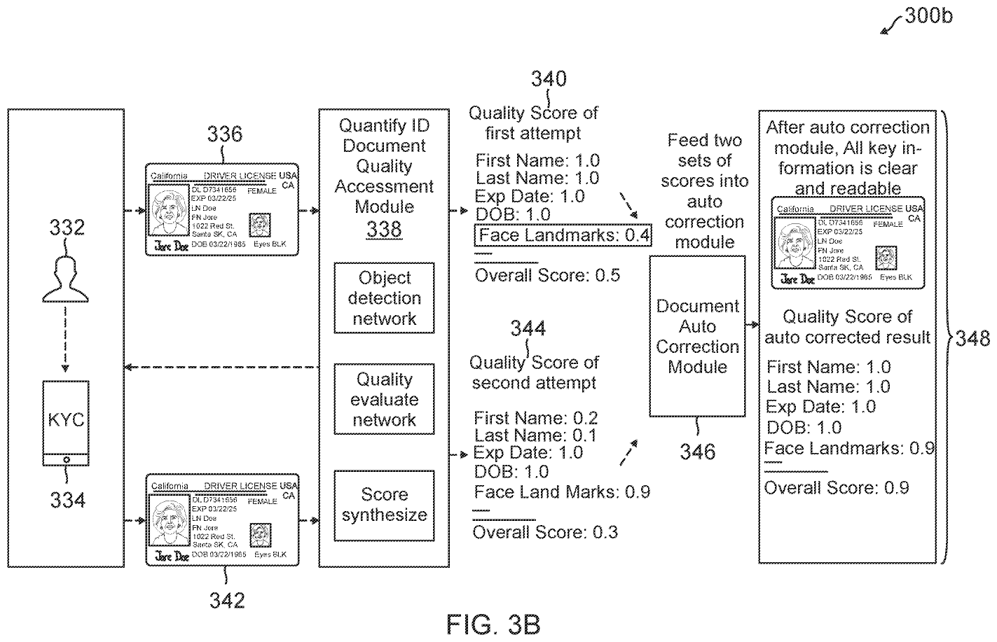

FIG. 3A-3B are exemplary diagrams 300a-300b of images processed by a neural network trained for interpretive and qualitative assessments of document image quality through assessing image data in key information fields, according to an embodiment. Diagrams 300a-300b include exemplary images of a document, such as drivers license, passport, school ID, employee ID, or other ID card, where the images may be processed for image quality assessments by service provider server 120 discussed in reference to system 100 of FIG. 1. In this regard, service provider server 120 may output quality assessments of images for document image submissions during document verifications.

In diagram 300a, a document image 302 may be captured of an ID card, such as a Texas driver's license that includes different KIFs for information that may be present and/or required or submitted for verification with a document verification system, such as to verify an identity of a user and/or the user's information (e.g., home address, city, state, or country of residence, DOB, etc.). When analyzing document image 302, an object detection NN may first detection a set of KIFs including KIFs 304-324, which may then be used to calculate scores for KIFs 304-324 and an overall quality score 326 based on a weighted sum or other weighted calculation of the scores for KIFs 304-324. For example, first graphic KIF 304 may correspond to a graphic on the document in document image 302, which may be used to verify the document (e.g., a RealID graphic, a hologram, or the like). An image quality description and quality assessment may also be provided with first graphic KIF 304, shown as “low resolution” and “no quality loss,” which may indicate that the image has a low resolution of the graphic for first graphic KIF 304 but no quality loss in the image.

In diagram 300a, KIFs 304-324 during include a state KIF 306, a document description KIF 308, a document identifier KIF 310, an expiration date KIF 312, a DOB KIF 314, a name KIF 316, a user image KIF 318, a document hologram KIF 320, an address KIF 322, and a signature KIF 324. Each of these KIFs are shown with a corresponding description, which may indicate the quality in each KIF, document information present in each KIF, and/or issue with recognizing, determining, and/or extracting the information for the document in each KIF. Further, each of KIFs 304-324 may have a corresponding image quality score for the image data present in the field, section, or area associated with each of KIFs 304-324. These scores may be used to determine overall quality score 326, which may be calculated using an algorithm or function that may weigh each of the scores for KIFs 304-324 and determine a score that factors in each of these weighted scores. Thus, overall quality score 326 may be output, which may be compared to a threshold to determine if document image 302 is of sufficiently high quality for processing. If meeting or exceeding a threshold, document image 302 may be approved for submission and processing by a document verification system.

However, if at or below the threshold, repair of document image 302 and/or request for recapture of the document in one or more additional images may be performed and/or requested. For example, each of the scores for KIFs 304-324 shows a corresponding score related to quality loss based on the image data for the corresponding KIFs and present in document image 302. The scores may indicate a loss based on image quality and lack of sufficient clarity of the image, which may impede reading, extracting data from, or otherwise accurately processing corresponding image portions. In this regard, document identifier KIF 310 is shown with a score of 0.9 and a description having the extracted ID card (driver's license) number, indicating high quality image data and ability to read or extract the required document information for document identifier KIF 310 in document image 302. However, name KIF 316 is shown with a score of 0.2 and a description of blurry, which may indicate that repair of the image (e.g., to reduce glare, perform image correction, etc.) or recapture of the document in document image 302 may be required.

Further, expiration date KIF 312 is shown as expired, which may require the user to capture another document or otherwise verify the document in document image 302 and/or information for the document. With each of these KIFs that include unclear image data or image data that is unable to be processed, overall quality score 326 may be impacted, which may cause document image 302 to fail a quality assessment and indicate that document image 302 is inadequate to be submitted for document verification (e.g., is likely to fail or be refused for document verification). This may allow a qualitative description for issues in image quality to be provided with image assessments during document verification. Thus, with overall quality score 326, a reason for image quality assessment failure or inadequate quality may also be output, which may allow a user or an image processing system to correct image capture and/or repair or adjust document image 302

In diagram 300b, a series of interactions are shown when submitting one or more document images for document verification, which may be performed during interpretive and qualitative assessments of document image quality for document image submissions. For example, initially, a user 332 may go through a “know you customer” (KYC) information submission flow 334 that requires a document submission and verification during an interaction 1. During interaction 1, user 332 may capture an image of a document and submit that image for verification during KYC information submission flow 334. At an interaction 2, a first document image 336 of the document, such as a driver's license, is submitted, but first document image 336 may have glare or other image, visual, or lighting effect that causes the image to be unclear (e.g., a portion is unreadable due to the glare). Thus, in first document image 336 provided during interaction 2, one or more KIFs may have image data that is unreadable, unextractable, or cannot be processed for the document verification. As such, when submitted to a quality assessment module 338 includes an object detection NN, a quality evaluation NN, and a score synthesis, a corresponding quality assessment may indicate that first document image 336 is of inadequate or insufficient quality to be verified.

As such, during an interaction 3, a first quality score 340 may fail to meet or exceed a threshold, and an indication is provided that a face landmark that is blurred or obscured due to the glare is the reason for first document image 336 failing the quality assessment. As such, it may be requested by quality assessment module 338 that user 332 recapture the document in a second document image 342 during an interaction 4. Interaction 4 may further indicate to the user that glare was the issue in image quality and the image of the user on the document that was captured in first document image 336 was unclear or obscured due to the glare. Thus, an instruction may be provided to recapture the document at another angle in second document image 342.

During an interaction 5, second document image 342 is captured, and provided to quality assessment module 338. Second document image 342 may be captured at a different angle that reduces the glare to the user's image on the document when captured, which may resolve the issue with first document image 336. However, in second document image 342, a first and last name may be obscured or made unreadable due to further glare when second document image 342 is captured of the document at a different angle. However, a document autocorrection module 346 may be utilized to perform image correction and/or merging at an interaction 6. This may allow for second document image 342 to assist in correcting first document image 336.

For example, document autocorrection module 346 may take highest scoring image assessment portions of each image and combine such portions into a merged or combined image, thereby providing an image with all portions meeting or exceeding a required image clarity threshold. In further embodiments, combining of images may be done those image pixel and/or portion updates, image juxtapositions, and/or algorithmic comparisons and mergers of images by document autocorrection module 346. When executing document autocorrection module 346 for image synthesis using two or more images, the best one of the images may be used as a template, such as the one that has a highest overall quality score but having one or more KIFs (e.g., DOB) missing. Document autocorrection module 246 may crop out the DOB or other field from the other one of the two images that has a highest quality score for the field, and the cropped image field is then resized into the size of the template's DOB field size. Document autocorrection module 246 may paste this portion back to the template's DOB field position. This crop-and-paste operation may cause image pixels to shift because of resizing, and therefore a trained Generative Adversarial Network may be used to convert the edited template back to original appearance. As such, the image data from each of first document image 336 and second document image 342 may be used to image merging and/or correcting to obtain a third document image 348 at an interaction 7. Interaction 7 may allow for image correcting to recreate image data for each KIF that is required during document verification. Thus, after interaction 7, third document image 348 may be of sufficient quality that third document image 348 may be submitted to a document verification for processing when completing KYC information submission flow 334.

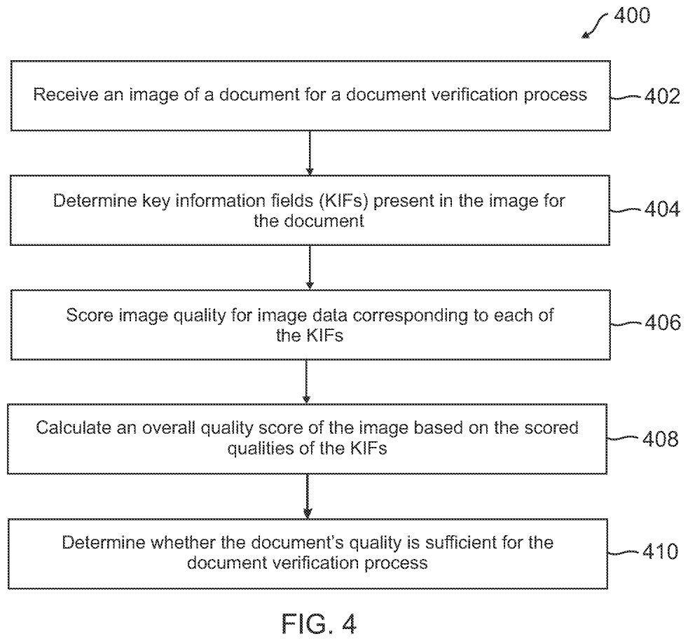

FIG. 4 is a flowchart 400 for interpretive and qualitative assessments of document image quality for document image submissions, according to an embodiment. Note that one or more steps, processes, and methods described herein of flowchart 400 may be omitted, performed in a different sequence, or combined as desired or appropriate.

At step 402 of flowchart 400, an image of a document for a document verification process is received. The image may be captured and/or generated from interactions and activity of a user with an online service provider and corresponding computing services, such as in order to provide a document to the service provider for processing, verification, and/or authentication of the user. In other embodiments, the document may be provided for data extraction, such as text or object data extraction and processing. In this regard, the user may be prompted to capture an image of the document, such as by using a mobile smart phone with corresponding digital camera.

At step 404, KIFs present in the image for the document may be determined. The KIFs may be determined using an object detection NN that is trained using past images of documents that may be annotated and/or labeled with corresponding KIFs and KIF descriptions or identifiers. In this regard, the NN may correspond to an artificial NN or other NN, such as a ResNet, Darknet, or the like, which may allow for identification of objects in images and the description or identification of those objects and corresponding sections or areas of the images. Further, the NN for object detection may also determine a document type and/or classify the document present in the image as the document type. Prior to processing by the NN for object detection, data preprocessing may occur. The preprocessing may correspond to general image and/or pixel cleansing, null value replacement, and the like. Thereafter, the NN trained for object detection may process input image data and identify the KIFs of the document that are predicted or classified to be present and/or visible in the image.

At step 406, image quality for image data corresponding to each of the KIFs is scored. A second or further NN, such as an image quality assessment and/or object classification NN, may be used to score image data for its quality in adequately capturing and/or providing the underlying information in the document. In this regard, the NN trained for object classification may correspond to a ResNet or other artificial NN that classifies objects present in the image data for each KIF with regard to the aforementioned quality. The scoring may provide a value that indicates whether the image data properly or adequately captures the information from the document and may be used to reading, verifying the document, and/or extracting data for the document from the image. With each score, a corresponding description of the score and/or image data for the KIF may be provided, such as “unclear”, “not present”, “visible”, or the like.

At step 408, an overall quality score of the image is calculated based on the scored qualities of the KIFs. An algorithm may be utilized to weight each individual KIF quality score and compute the overall quality score. In this regard, the overall quality score may represent a worthiness of submission of the image in order to verify the captured document in the image. Thus, the overall quality score may be compared to a threshold score requirement to approve or pass the image for submission to the document verification process. However, if failing to meet or exceed this threshold, the image may be determined to be of insufficient quality for processing. Further, if certain KIFs are unreadable, unclear, or not present, the overall quality score may be sufficiently impacted to prevent meeting or exceeding the threshold.

At step 410, it is determined whether the document's quality is sufficient for the document verification process. If sufficient, the image may be approved and/or recommended for submission to the document verification process. However, if insufficient, repair of the image and/or recapture of the document in further images may be suggested and/or performed. For repair, image processing effects may be used to attempt to make image data more readable or extractable. When recapturing additional images, images may be combined and/or image data extracted and/or used from multiple different images in order to provide an adequate quality image for submission.

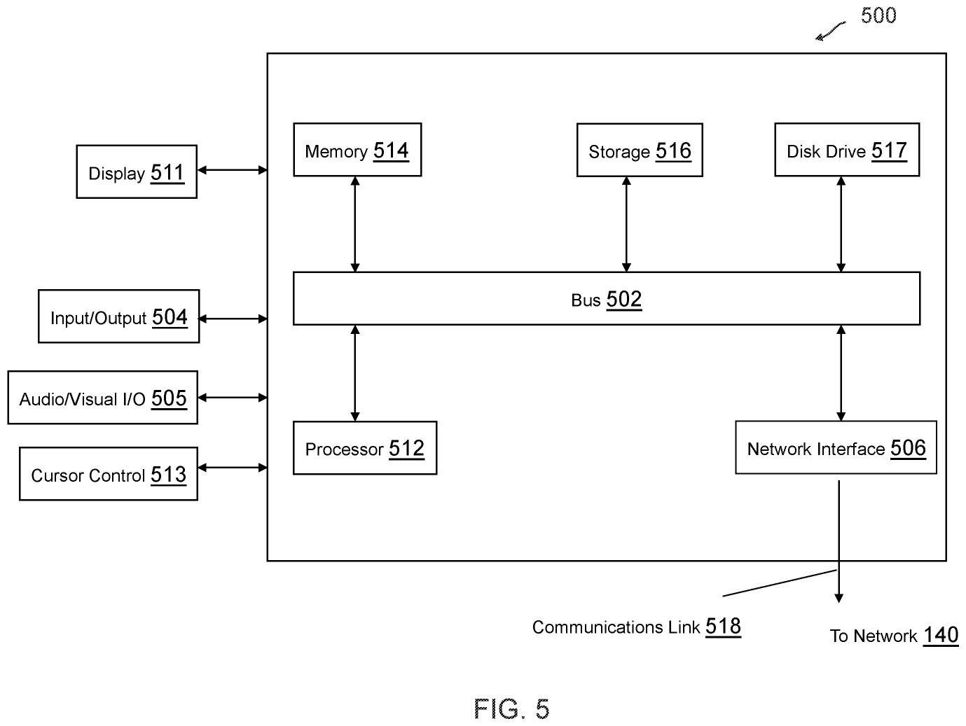

FIG. 5 is a block diagram of a computer system 500 suitable for implementing one or more components in FIG. 1, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 500 in a manner as follows.

Computer system 500 includes a bus 502 or other communication mechanism for communicating information data, signals, and information between various components of computer system 500. Components include an input/output (I/O) component 504 that processes a user action, such as selecting keys from a keypad/keyboard, selecting one or more buttons, image, or links, and/or moving one or more images, etc., and sends a corresponding signal to bus 502. I/O component 504 may also include an output component, such as a display 511 and a cursor control 513 (such as a keyboard, keypad, mouse, etc.). An optional audio input/output component 505 may also be included to allow a user to use voice for inputting information by converting audio signals. Audio I/O component 505 may allow the user to hear audio. A transceiver or network interface 506 transmits and receives signals between computer system 500 and other devices, such as another communication device, service device, or a service provider server via network 140. In one embodiment, the transmission is wireless, although other transmission mediums and methods may also be suitable. One or more processors 512, which can be a micro-controller, digital signal processor (DSP), or other processing component, processes these various signals, such as for display on computer system 500 or transmission to other devices via a communication link 518. Processor(s) 512 may also control transmission of information, such as cookies or IP addresses, to other devices.

Components of computer system 500 also include a system memory component 514 (e.g., RAM), a static storage component 516 (e.g., ROM), and/or a disk drive 517. Computer system 500 performs specific operations by processor(s) 512 and other components by executing one or more sequences of instructions contained in system memory component 514. Logic may be encoded in a computer readable medium, which may refer to any medium that participates in providing instructions to processor(s) 512 for execution. Such a medium may take many forms, including but not limited to, non-volatile media, volatile media, and transmission media. In various embodiments, non-volatile media includes optical or magnetic disks, volatile media includes dynamic memory, such as system memory component 514, and transmission media includes coaxial cables, copper wire, and fiber optics, including wires that comprise bus 502. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 500. In various other embodiments of the present disclosure, a plurality of computer systems 500 coupled by communication link 518 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory; and
one or more hardware processors coupled to the non-transitory memory and configured to read instructions from the non-transitory memory to cause the system to perform operations comprising:
accessing a first image of a document for a user that is submitted for a document verification process of the document;
executing an image processing neural network (NN) framework comprising at least a first NN and a second NN, wherein the first NN is associated with an object detection operation for the document verification process, and wherein the second NN is associated with an object classification operation for the document verification process;
identifying, using the first NN, a plurality of key information fields (KIFs) of the document in the first image for the object detection operation;
evaluating, using the second NN, a quality of each of the plurality of KIFs in the first image for the object classification operation, wherein evaluating includes determining a score for the quality of each of the plurality of KIFs;
calculating an overall document quality score of the first image containing the document based on the score for the quality of each of the plurality of KIFs and a document type of the document; and
executing an action with the first image for the document verification process for the user based on the overall document quality score.

2. The system of claim 1, wherein, prior to the accessing, the operations further comprise:
accessing the first NN for the object detection operation trained using training data associated with a plurality of training documents; and
accessing the second NN for the object classification operation trained based on image data in each of the plurality of KIFs from the plurality of training documents.

3. The system of claim 2, wherein the training data comprises training images of the plurality of training documents having labels for the plurality of KIFs in each of the plurality of training documents and corresponding document types for the plurality of training documents, and wherein the second NN is further trained using the training images to predict the quality of the image data in the plurality of KIFs.

4. The system of claim 2, wherein the first NN was further trained using the training data for document type predictions based on the training data.

5. The system of claim 2, wherein the second NN was further trained for confidence level predictions that the image data includes corresponding document data in the plurality of KIFs, and wherein the second NN comprises one of a Residual NN (ResNet) or an image assessment NN.

6. The system of claim 1, wherein the action comprises a request for the user to resubmit the document through a second image based on one of the plurality of KIFs having the quality at or below a threshold quality.

7. The system of claim 6, wherein the operations further comprise:
determining the one of the plurality of KIFs having the quality at or below the threshold quality based on the evaluating; and
identifying the one of the plurality of KIFs to the user during the request.

8. The system of claim 7, wherein the identifying the one of the plurality of KIFs further comprises providing an instruction for the user that includes information for capturing the second image having a higher quality of the one of the plurality of KIFs in the second image than in the first image.

9. The system of claim 1, wherein the action comprises an approval of the first image for a submission of the document for the document verification process, and wherein the operations further comprise:
performing the submission to the document verification process of the first image.

10. The system of claim 1, wherein the identifying, using the first NN, and the evaluating, using the second NN, are based on the document type of the document, and wherein the first NN is configured to determine the document type in correspondence with the identifying.

11. A method comprising:
receiving a first image of a document requested to be verified by a service provider;
detecting, using a first neural network (NN) of an image processing NN pipeline, a plurality of key information fields (KIFs) of the document that are present in the first image, wherein the first NN is configured to perform object detections in processed images, and wherein each of the plurality of KIFs include a portion of image data from the first image;
scoring, using a second NN of the image processing NN pipeline, the portion of the image data in each of the plurality of KIFs, wherein the second NN is configured to perform object classifications in the processed images;
calculating an overall document quality score of the first image containing the document based on the scored portions of the image data and a document type of the document; and
determining whether the document is capable of being verified in the first image based on the overall document quality score.

12. The method of claim 11, wherein the document is determined to be incapable of being verified in the first image, and wherein the method further comprises:
requesting a capture of a second image of the document.

13. The method of claim 12, wherein prior to the requesting, the method further comprises:
determining that the portion of the image data in a corresponding at least one of the plurality of KIFs is incapable of being read or repaired in the first image.

14. The method of claim 12, further comprising:
identifying an error in the first image that causes the document to be incapable of being verified in the first image; and
outputting the error with the requesting.

15. The method of claim 11, wherein the document is determined to be incapable of being verified in the first image, and wherein the method further comprises:
performing an image data repair of the portion of the image data in a corresponding at least one of the plurality of KIFs.

16. The method of claim 11, wherein the calculating the overall document quality score includes weighting each of the scored portions of the image data based on the document type of the document.

17. A non-transitory machine-readable medium having stored thereon machine-readable instructions executable to cause a machine to perform operations comprising:
receiving an image of a document for a document verification process of the document with a service provider;
detecting, using a first neural network (NN), a plurality of fields for key information in the document in the image;
scoring, using a second NN, a plurality of first qualities of image data present in the plurality of fields;
determining a second quality of the image of the document based on the scored plurality of first qualities of the plurality of fields and a document type of the document; and
determining, based on the second quality, whether to request a resubmission of the document, perform a repair of the image data in one or more of the plurality of fields, or submit the image for the document to the document verification process.

18. The non-transitory machine-readable medium of claim 17, wherein the first NN comprises an object detection NN modified by a key information field (KIF) extraction with a document classification.

19. The non-transitory machine-readable medium of claim 17, wherein the second NN comprises a quality assessment NN corresponding to one of an artificial NN or an image assessment NN.

20. The non-transitory machine-readable medium of claim 17, wherein the resubmission is requested with an identification of at least one of the plurality of fields having an insufficient quality of the image data present based on a corresponding one of the plurality of first qualities.
